(19) United States
(12) Patent Application Publication
(10) Pub. No.: US 2006/0068897 A1
(43) Pub. Date: Mar. 30, 2006

(54) Purchase of slot vouchers with electronic funds (improved method and apparatus)

(76) Inventors: Kirk E. Sanford, Henderson, NV (US); Thomas M. Sears, Hendersonv, NV (US); Robert V. Connelly JR., Henderson, NV (US)

Correspondence Address: SUE Z. SHAPER, P.C., 1800 WEST LOOP SOUTH, SUITE 1450, HOUSTON, TX, 77027, US

(21) Appl. No.: 10/953,032

(22) Filed: Sep. 29, 2004

(51) Int. Cl. G06F 19/00; G06F 17/00

(52) U.S. Cl. 463/25

(57) ABSTRACT

Apparatus and method for the purchase of gaming vouchers (slot vouchers) with commercial bank cards using electronic funds transfer including a kiosk located on a gaming floor proximate to gaming machines but separate from a particular gaming machine, an EFT reader and processing system, user interactive communication equipment, voucher issuing equipment and means for communicating with both a commercial EFT system and a voucher accounting system, and including personal daily limit options.

### FIELD OF THE INVENTION

The Invention relates to improved method and apparatus for “cashless gaming” and more particularly to improved methods and apparatus for purchasing slot vouchers with electronic funds. “Slot vouchers” are insertable into a slot machine or gaming machine to fund gaming activity, and are redeemable for cash. The invention anticipates systems that can use vouchers to fund other in-house activities such as table games. The invention relates to an automated system for voucher purchase with a card at a stand-alone kiosk, the kiosk located in the vicinity of but separate from particular gaming machines. The card would be a commercial banking debit and/or credit card or the like, utilizing commercial electronic funds transfer (EFT) systems. Preferably, the invention causes a bar coded or similar audit controlled voucher to be printed.

### BACKGROUND OF THE INVENTION

The gaming industry is rife with regulation and scrutiny: state, federal, and tribal. Fiscal security concerns are extraordinarily high due to the levels of money changing hands. Moral concerns are intense. Community groups monitor regulators with an intent to enforce a sense of social responsibility. Gaming is a political issue. Commercial efficiency jockeys with social responsibility for priority. Reluctance to change paralyzes decision making.

In such context, casino operators nonetheless have migrated toward what is being called “cashless gaming,” including “cashless gaming” machines. Handling cash is inefficient, time consuming and costly for a casino. Requiring cash is inefficient, unsanitary and to a certain extent unsafe for players, cash being the ultimate bearer instrument.

One “cashless gaming” system for slot machines teaches providing equipment, integrated into each slot machine, for inserting a commercial bank card (credit or debit). The result is directly receiving playing credit at the machine. Use of the card at the machine is a convenience for the player, keeping the player from having to give up his/her seat in order to get more funds for play. This system initially anticipated that a player would cash out winnings and/or remaining playing credit for cash at the machine. Subsequent proposals include the ability to “cash out” at a machine for in-house credit and/or for commercial card account credit.

A second “cashless gaming” system proposes that a commercial bank (credit/debit) card be inserted into equipment associated with a particular slot machine and a “slot voucher” be printed at that machine in return. The voucher could then be read into that or any other slot machine via its bill reader to receive playing credit. The second system presumes the existence of machines that read vouchers with bill readers and provide playing credit in return. The second system also anticipates cashing out at machines in terms of vouchers. Newer machines can accept and/or print vouchers in lieu of, or in addition to, accepting and/or dispensing cash. Thus, a voucher may be read to yield playing credit as well as be printed to redeem winnings and/or remaining credits at a slot machine. This second system also allows patrons to directly access commercial bank account funds at a slot machine via a POS/debit type of transaction. Both the first and second systems entail the existence of accounting, communication and security hardware and software integrated into the machine.

In many jurisdictions there is no regulatory approval for using a card at a slot machine, however. Approval has been withheld because permitting players to obtain playing credit directly at a gaming machine by EFT has generated fears of encouraging compulsive gamblers, (even though there has been no documentation of this.)

A third more common and basic form of “cashless gaming” system has also existed. The third system provides for securing cash at ATM devices located from place to place around a casino floor. This securing of cash may be followed by a subsequent purchase of a voucher for cash at a separate kiosk, if desired. Unfortunately, ATM machines are expensive to own and maintain. Dealing in cash as they do, they entail high security and handling costs. Only a relatively few ATM machines are justified for a casino floor. ATM machines cost in the order of $15,000 to $17,000 each, involving all of the expense and security and servicing concerns associated with handling cash. A 1,000 slot machine casino, for example, would typically only find it cost effective to maintain 3 to 4 ATMs on the gaming floor. And the third system still involves handling cash, with its inconvenience and security concerns.

All the above “cashless gaming” systems have problems. The first two systems entail what turns out to be an excessive cost of installing POS/EFT hardware and software on each and every gaming machine. This hardware and software must satisfy stringent security standards associated with any equipment that directly interfaces with slot machines, thereby further increasing the cost of the hardware software, and regulatory approval. And the equipment ends up being under-utilized. Most of the time it sits inactive while a player plays the game. Furthermore, promoting obtaining gaming funds from commercial card accounts directly at a gaming machine is viewed by some as exhibiting insensitivity to a casino's social responsibility. Although it is not documented, it is perceived to be beneficial to interpose some interruption requiring a player to at least physically leave a machine to access funds by EFT.

In regard to the third system discussed above, it is inconvenient and inefficient from the player's standpoint to require a player to visit remote ATM machines, possibly standing in line. And cash must still be handled by the player, even if the player subsequently exchanges the cash for a voucher.

The instant invention teaches an improved system for “cashless gaming,” improved from the above system in terms of efficiency, cost and social responsibility. The equipment of the instant invention is more cost effective because (1) it avoids dealing with cash; (2) by being separate from any particular gaming machine, it avoids having to meet the high security standards set for hardware and software directly associated with a gaming machine; and (3) by being associated with a plurality of gaming machines, it is not under-utilized. The instant invention can be perceived by many as socially responsible in that players are not permitted to use a commercial bank card directly at a machine for securing playing credit. Rather, securing more playing credit requires interrupting game play. The equipment of the instant invention is efficient for the player. Being sufficiently small and inexpensive, it can be located in a plurality of locations proximate to individual banks of gaming machines. By not involving handling cash and by requiring only one stop at a kiosk, the instant invention is safer and more efficient for customers, supporting casinos eager to maximize customer service while abiding by community perceptions of social responsibility. The instant invention particularly fits a need where social responsibility is a high priority, where regulatory changes take large amounts of time and where cost efficiency is a significant concern.

While existing software products perform ATM/POS/debit and credit card authorizations on cash dispensing devices such as ATMs, one aspect of the instant invention includes the development of POS/debit and credit card software that may be integrated into voucher dispensing kiosks which are subject to a high reliability and accountability standard of a casino in general, although not subject to the very high scrutiny imposed upon software directly associated with a slot machine. One achievement of the instant invention is a cost effective development of POS/debit and credit hardware and software that meets the appropriate high accountability standards of the gaming regulatory business and that can be implemented in stand-alone kiosks.

While the ultimate in funds dispensing convenience for slot players might be an ATM/POS/debit terminal that interfaces directly with a particular gaming machine, deployment of such a product has been a slow process, inhibited its inherent disadvantages. Political and regulatory challenges have surrounded a “one-on-one” relationship with a gaming machine, as well as cost effective concerns. In the instant invention, a cost effective “proximity” more than balances the convenience of a direct one-on-one relationship. The instant end of bank (EOB) kiosk requires a player to physically step away from a gaming machine to obtain additional funds electronically. This is a concept advocated by problem gambling support groups. However, the distance away is not inconveniently far, and an EOB kiosk can service a greater percent of players since it need not stand inactive while a game is being played.

Based on the results of a pilot program with a voucher issuer associated with and integrated into particular slot machines, it appears clear that people will take advantage of the convenience of purchasing slot vouchers or (“debit tickets”) from a device in proximity to gaming machines. The pilot results further showed, that “end-cap” locations, especially those in high traffic areas, processed the highest transaction volumes. Slot players, thus, were using such end-cap slot machines with voucher purchase capability as “ATM” during low game-occupancy periods.

The pilot results further showed that during high game-occupancy periods the terminals were essentially “out-of-service” while games were being played. This indicates that such one-on-one equipment is being not cost effectively utilized when attached to individual machines.

The debit ticket kiosk is viewed, thus, as an optimum solution. Providing this service in proximity to slot machines addresses the following challenges and concerns:
a) Casino operator concern about public perception (appearing predatory)
b) Casino operator concern about regulatory scrutiny (state level, NIGA)
c) Opposition from problem gambling support groups
d) Regulator apprehension and concern about public perception
e) Regulatory scrutiny because of interface to gaming machine
f) Dependence on game hardware and firmware, adding time and cost to installation
g) Capital costs too high to install on 100% of games on most casino floors
   EOB kiosks make further financial sense because it is not likely cost effective to install EFT equipment in particular on low denomination games (or low occupancy multi-denomination games) given the current cost of game-level hardware. Further, installation of EFT equipment on particular slots requires access to the gaming machines to install a radio and antenna. Such installation requires access to the drop compartment in the slot base to install the POS terminal mount and route cables to the radio. Access to these areas requires properly licensed personnel and the presence of a slot technician and/or security guard. This creates scheduling challenges and adds time to the installation process. These issues go away with the EOB Kiosk.

### SUMMARY OF THE INVENTION

The instant invention discloses printing gaming device vouchers, or “slot vouchers,” upon an authorization of funding by a POS/debit and credit card financial network in a POS transaction at a stand-alone kiosk, the kiosk structured and sized to be located proximate a plurality of gaming machines but independent of any particular machine. The automated, interactive stand-alone kiosk would preferably include a POS terminal with a card swipe reader, a screen, a key pad, and a voucher printer or issuer. The stand-alone kiosk may or may not include wireless technology. Means to communicate both with commercial card networks and with an in-house gaming accounting system is provided.

In operation, patrons would preferably swipe a debit or credit card, enter a Personal Identification Number, request an amount, agree to any additional fees that may be charged and optionally request or decline a receipt for the transaction. The patron may be given an option to enter a personal daily limit for the card. The request would be first forwarded to a financial transaction processor who submits the request for funding through a wired and/or wireless communication network. The transaction packet would be forwarded to commercial banking and card association networks who submit the request to the issuing bank or their agent for approval.

If the transaction is denied, a denial message would appear at the stand-alone kiosk screen and the transaction would be terminated. If approved, and preferably only if approved, the authorized transaction would be submitted to a server connected to a casino's voucher management system and/or database. The voucher management system and/or database would (preferably) interpret the approval message, validate the transaction in-house and create a voucher record with a unique identification that includes the amount. The voucher system and/or database then would message a server that the voucher record has been created, whereby the server would send a message of approval to the stand-alone kiosk and cause a voucher printing device to print a voucher, and a receipt if requested. Both the processor system and the voucher management system would retain audit trails and reporting features to reconcile and balance activity.

One aspect and advantage of the instant invention over a POS device at a slot machine is that validation of the transaction by the in-house accounting system is simplified. The viability of a particular slot or gaming machine need not also be validated every time a voucher is printed. This is one significant advantage of a stand-alone kiosk having no connection to a particular gaming machine.

The invention should be a valuable “cashless gaming” product for casino operators in multiple ways. Cash handling is expensive and time consuming. Cash methods require patrons to insert currency directly into a slot bill and/or coin validator to fund gaming activity. In the event a patron must access further cash, in most jurisdictions the patron must perform several steps to obtain the additional cash, such as initiate an ATM, cash advance, wire transfer or check transaction. The casino must maintain adequate funds to support cash advance, wire transfer and check cashing activity. The ATM provider must contract for cash services from banking institutions and armored car service providers. Cash inserted into each slot device must be periodically extracted from the devices, counted and verified, and then re-circulated to either the casino floor or deposited in bank accounts. By purchasing a voucher with remote funds in one step, no cash is involved in the transaction and account settlement occurs electronically in a daily batch process.

The invention improves customer service. When from time to time a patron desires to obtain additional funds from commercial bank sources after the patron has initiated play, rather than seeking out a remote ATM device or a check cashing service, both likely to be located a substantial distance away from the particular gaming device the customer is currently playing, the player can access nearby stand-alone kiosks. The stand-alone kiosks contemplated under the instant invention would be sufficiently inexpensive and compact as to be able to be located near the slot devices, providing convenient service for those who wish to continue their gaming activity.

The invention also eliminates currency transaction reporting. When cash is used in a transaction where the amount of cash exchanged is equal to or greater than $10,000 within a 24-hour period, a consumer must complete a currency transaction report as required under Federal Law (Title31). This is a time consuming and bothersome process for both patrons and casino employees, and includes considerable risk of fines if not properly filed in a timely manner. Purchasing slot vouchers through an electronic funds transfer involves no currency and does not require separate cash transaction reporting. This is due to the electronic recording inherent within the banking system.

The invention increases guest safety. Gaming patrons no longer need to carry cash when visiting an establishment. Funds can now be issued electronically and recorded on vouchers that are no value outside the casino establishment. A certain ability to protect against loss and theft exists with a voucher. A voucher is less of a bearer instrument than cash.

### BRIEF DESCRIPTION OF THE DRAWINGS

A better understanding of the present invention can be obtained when the following detailed description of the preferred embodiments are considered in conjunction with the following drawings, in which:

FIGS. 1-3 illustrate a stand-alone automated interactive kiosk according to one preferred embodiment of the instant invention, situated or structured and designed to be located end of bank (EOB.)

FIG. 4 illustrate two sides of a preferred embodiment of a voucher, as well as a receipt.

FIGS. 5-19 illustrate optional preferred embodiments for transaction flows for the inventive system.

FIG. 20A illustrates one topology for an end of bank kiosk and supporting systems.

FIG. 20B illustrates one option for a server level implementation.

FIGS. 21-23 illustrate three optional transaction flow options for preferred embodiments of the system.

The drawings are primarily illustrative. It would be understood that structure may have been simplified and details omitted in order to convey certain aspects of the invention. Scale may be sacrificed to clarity.

### DESCRIPTION OF THE PREFERRED EMBODIMENTS

The term voucher or “slot voucher” should be understood to comprehend and include tickets, scripts, coupons, receipts, drafts or other printed medium usable to secure cash or credit or goods or services in a casino. In general, embodiments of the instant invention permit the purchase of a gaming machine voucher (typically called a “slot voucher”) using equipment proximate to but not integrated into a particular gaming device. The voucher is purchased through POS/debit, credit or other stored value source funding via a banking card association network and/or stored value account. Authorization for the funding causes a bar coded or similar audit controlled voucher to be printed or issued. The voucher then can be inserted into a slot bill validator, for instance, or a similar device for reading vouchers, to fund gaming activity. The voucher could also be exchanged for cash at a self-serve redemption kiosk or at a cashier window. The system can easily be expanded to include vouchers that may be used to fund activity for table games as well.

The instant invention discloses a process to enable the printing of gaming device vouchers (bar-coded tickets) at stand-alone kiosks based upon electronic funds transfer (EFT). Transaction options include the use of debit cards, ATM cards, credit cards and stored value cards. Compact kiosks for such purposes are preferably locatable at the end of banks (EOB) of slot machines, such as at the end of a bank of 40 machines, to maximize convenience to casino patrons.

An automated interactive kiosk preferably includes a PIN pad (for Personal Identification Number entry), a card reader that supports magnetic stripe cards and smart cards and a display, as well as a voucher printer. Communication means are required for both the EFT network and for the casino voucher accounting system.

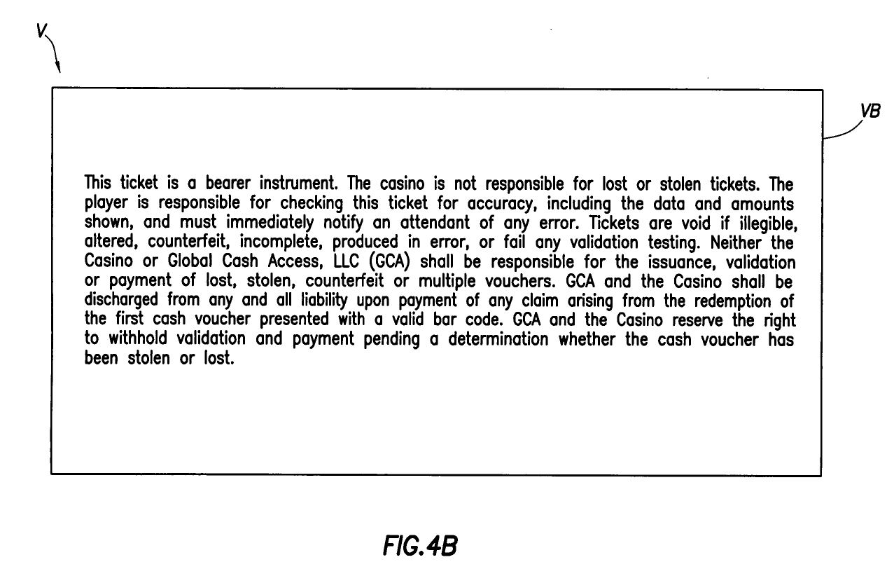

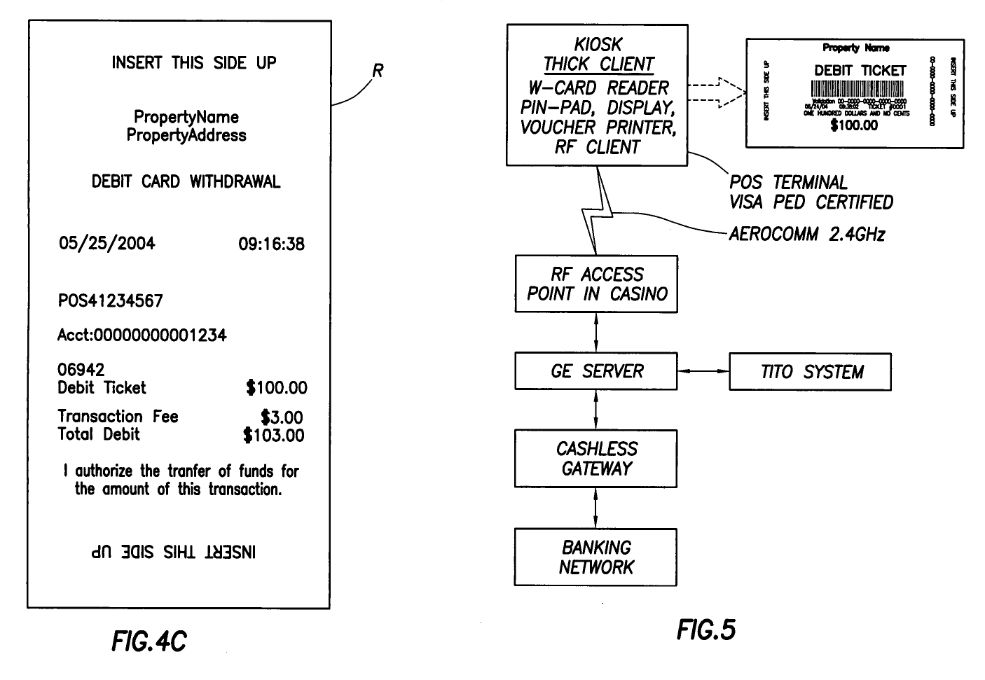

The kiosk preferably generates bar-coded vouchers similar to the debit ticket, with front side VF and rearside VR, as shown in FIGS. 4A and 4B, which voucher can be inserted into a bill acceptor of a slot machine to fund gaming activity or can be redeemed for cash at a casino cage or cashier booth or redemption kiosk. The kiosk preferably offers patrons optional receipts similar to the receipt R shown in FIG. 4C.

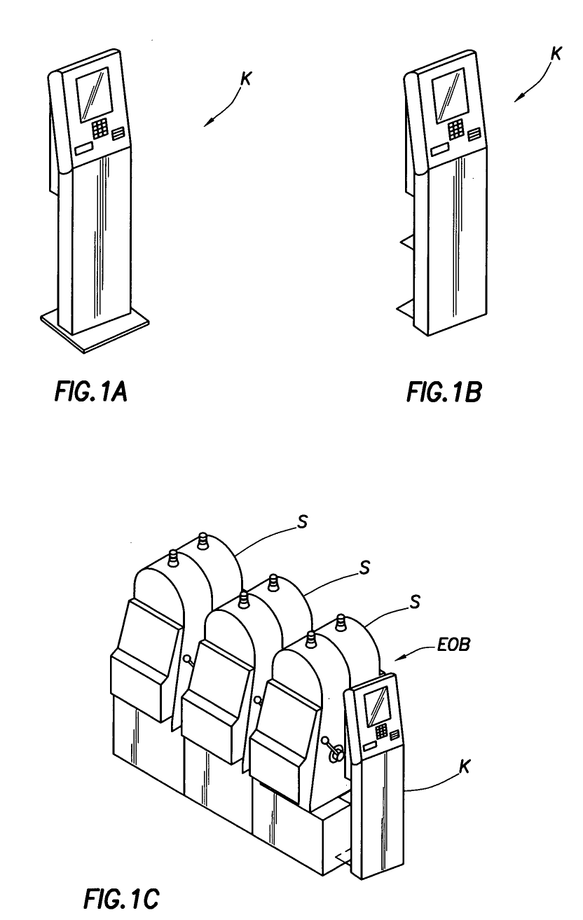

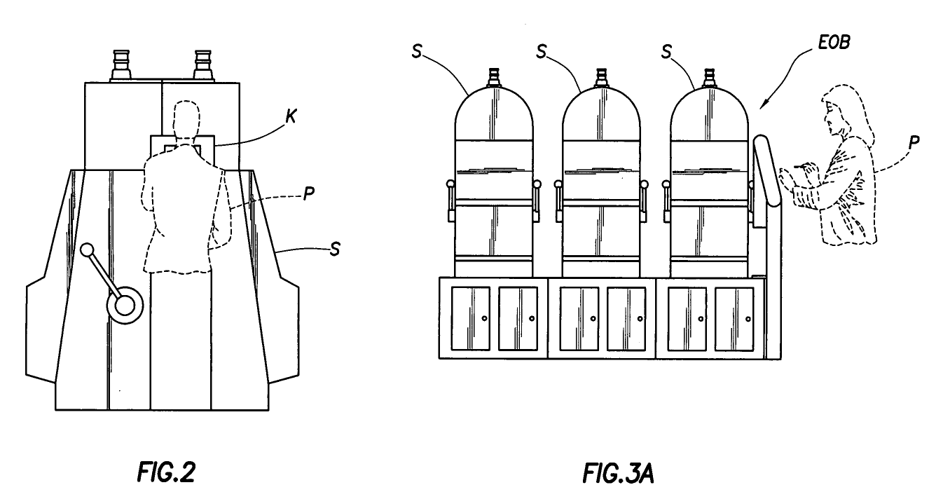

FIGS. 1-3 illustrate physical embodiments of preferred apparatus for the purchase of slot vouchers with electronic funds. The apparatus is referred to as a stand-alone automated interactive kiosk, illustrated as kiosk K in FIGS. 1-3. It can be seen that kiosk K is illustrated as being locatable at the end of a bank (EOB) of slot machines S. A patron or a player P is illustrated operating the kiosk K in FIGS. 1-3. Typically a kiosk would include an EFT card reader CR, user interactive communication equipment, such as a PIN-pad KP and a display D, and voucher issuing equipment TP. Typically the voucher issuing equipment TP would print a voucher V in accordance with authorized printing instructions.

The kiosk includes means for communicating with an electronic funds transfer system as well as means for communicating with an in-house voucher accounting system. Means for communicating with an electronic funds transfer system would preferably include communicating through an EFT financial processor. Means for communicating with a voucher accounting system would preferably include means for verifying a voucher that is to be issued. That is, the voucher issuing process preferably receives verification from a voucher accounting system.

Receipt issuing equipment is preferably associated with the kiosk. Preferably a patron has an option of receiving or not receiving a receipt for a transaction. An option may be provided for a patron to self-select a personal daily limit for receiving funds from the card for gaming.

In preferred methodology, a patron swipes or inserts a debit or ATM card at a kiosk. The patron enters a PIN, such as by using a PIN-pad, and an amount. The patron confirms the surcharge that will be charged to the patron's account and requests or declines a receipt.

In a second step a message is preferably sent via rf (wireless) or cable connection to a financial processor and its system. A financial processor sends or forwards the request, properly formatted, to an appropriate banking network for a debit withdrawal authorization. The banking network approves (or disapproves) the debit withdrawal transaction and communicates the message back to the financial processor system.

Presuming an approval of the debit withdrawal, the financial processor system sends a voucher request message to a voucher accounting a system, referred to as a TITO system. The voucher accounting system responds to the financial processor with a voucher authorization message, preferably including appropriate validation data. The financial processor forwards the voucher authorization message to the kiosk. The kiosk prints a bar coded voucher in the amount of the debit withdrawal request. Subsequently, the patron can redeem the voucher for cash at a casino cage or a cashier booth, or insert it into a bill acceptor of a properly equipped gaming machine. In an alternate embodiment, the voucher accounting system communicates directly with the kiosk. This permits the voucher accounting system to verify printer status. Such communication means would likely include rf or cable connection. The voucher accounting system can than confirm to the financial processor that the printer is on line and ready. In such embodiments the voucher accounting system can send a message directly to a voucher printer at the kiosk to print a bar coded voucher in the amount of the debit withdrawal request.

To say that a kiosk is located on a gaming floor separate from a particular gaming machine means that the kiosk is not integrally connected with a particular gaming machine, by hardware and software. The kiosk is not integrated into that gaming machine. A stand-alone kiosk could be set up adjacent to and/or touching and/or physically supported by a gaming machine, and is preferably located at the end of a bank of slot machines. The kiosk is separate, however, from any particular gaming machine in that it has no integration with that particular gaming machine and its electronics. Said otherwise, simultaneous use of the kiosk and any particular gaming machine by different patrons should be possible.

FIGS. 1 to 3 illustrate preferred designs for a compact kiosk K that will dispense debit tickets V via PIN-based EFT transactions. The kiosk design is preferably small enough to be installed at the end of a bank of slot machines, maximizing convenience to casino patrons. A sleek, compact design and a secure, stable installation are preferred features of the kiosk design for this implementation.

Key terms for understanding the embodiments of FIGS. 5 to 23 are as follows:
GE (gaming environment server)—the GE server is a front-end communications server that funnels all communications upstream with the Cashless Gateway and downstream to the TITO server. In addition to messaging switching functions, it has application logic for error handling and logging. There is no persistent or critical application data stored in this server.
CG (cashless gateway)—the CG serves as the communications nexus and provides the application intelligence to synchronize transactions across components and reliably record transactions and enforce security. This component interfaces to all Gaming Environment servers, the Database, and the banking networks via USAP. The CG performs the function of a financial transaction processor. A CG is a gateway for cashless access.
TITO System—generic reference to ticket-in/ticket-out systems. The ticket database resides on the TITO system server and is maintained by casino personnel.
Thick Client—in a client/server architecture a thick client performs the bulk of the data processing operations. The data itself is stored on the server. For purposes of this document, thick client refers to a PC or POS terminal at the kiosk that contains the application software and has relatively strong processing capability.
Thin Client—in client/server applications a thin client is designed to be especially small so that the bulk of the data processing occurs on the server. For purposes of this document, thin client refers to a low cost processing solution at the kiosk whereby screen images and prompts are resident on the client and application software resides on the server.
Zero Client—in client/server applications the zero client is the lowest cost approach at the client level whereby all data processing occurs at the server. For purposes of this document, this solution has been included in order to illustrate all design options. This is not the initially preferred option.
Visa PED Certification—device approval process mandated by Visa International. It deals with the physical security of POS terminals (i.e. tamper-proof) and security procedures for how encryption keys are stored, transported and injected.
EMV Certified—Acronym for Europay, Mastercard, Visa organization. This certification deals with worldwide standards at the firmware and circuit board level and how devices must function and inter-operate with one another.
“Delivery of Funds”—this expression is used in this document to conceptually describe the messaging that takes place between a server and the kiosk/printer. In some design options the TITO server tells the kiosk/printer to generate a ticket, in other design options the GE server tells the kiosk/printer to generate a ticket. In reality, this communication involves a message containing ticket data directing the kiosk/printer to generate a debit ticket.

(In regard to the actual ‘finds,’ it should be understood that although a patron's bank account is debited in real time, a casino essentially “fronts” the funds to the player in the form of a cashable debit ticket because the casino is not reimbursed until two business days later by the banking networks.)

The instant invention discloses apparatus and process to enable the printing of gaming device vouchers (bar-coded tickets referred to as debit tickets or slot vouchers) at stand-alone kiosks based upon electronic finds transfers (EFT). Although initially a kiosk will dispense slot vouchers through the use of debit cards, ATM cards, credit cards, and stored value cards, software “hooks” can be built into a unit for future support of promotional tickets and self-serve comp slip creation (bonus point redemption via interface to player tracking systems). No cash need be stored in the kiosk; therefore ATM (cash dispensing) transactions are not necessary.

Such compact kiosks can be located at the end of banks of slot machines, or nearby, to maximize convenience to casino patrons. Key aspects of the kiosk are a small, sleek design, low cost and high reliability. Design features include:
1. Compliance with gaming regs and bank network rules
2. Reliability
3. Ease of manufacturing
4. Low cost
5. Use of minimal resources from gaming machine manufacturerers
6. Ease of installation and maintenance from casino perspective (i.e. slot moves, ticket stock replenishment)
7. Ease of installation.

Preferred kiosk design includes an extremely small footprint, the smaller the better. The less intrusive the unit, the greater the number of installation options there are across a slot floor.

An ideal installation method for a kiosk would be to embed it into or on the side of slot machine cabinets at the end of a bank, to the extent casino operators and gaming regulators will allow this. The second best design approach would be a flat kiosk that takes up as little space as possible situated in a walkway between banks. One goal is to minimize the depth of the kiosk to ensure that the kiosk creates no traffic flow issues for the casinos.

Preferred kiosk attributes include:
1. Aesthetics—an attractive, sleek, “cutting edge” design; one that blends in with the aesthetics of a slot floor.
2. Durability—a durable unit that can withstand the wear and tear of a 24×7 casino environment.
3. Quality—Transaction reliability is paramount. No more than 1 unexpected error per 5,000 transactions.
4. Cost—Component hardware cost able to be significantly reduced below ATM machine costs.
5. Size—Limit hardware depth due to the limited space between slot machines in the average casino.
6. Power cable—ideally should be 10 feet in length with an in-line power adaptor, not wall mount. Ideally modular at the device so cord can be fed through metal stalk mount and cable holes in slot base.
7. Expandability—designed at the software level with future expandability in mind (i.e. promo tickets, bonus point lookup and comp creation); without ATM functionality or bill breakage (cash dispensing) because of desire for a small footprint. (Test results show that demand for debit tickets on a slot floor is enough to make device successful.)
8. Processing Capability—Thin Client or Thick Client or Zero Client
9. Connectivity—Should support both hard-wire and RF (wireless) communications (proprietary 2.4 GHZ or 802.11, for example). The preferable implementation is wireless since this will allow casino operators to reconfigure their slot floors without having to pull new cable or re-route existing cable. (RS232 or TCP/IP to be determined)
10. PIN encryption—should meet ANSI standards for “TDES” (triple DES) and “DUKPT” (derived unique key per transaction).
11. VISA Certification—should be a VISA approved PED.
12. EMV Certification—should meet EMV (Europay, Mastercard, Visa) worldwide standards for firmware and circuitry and how POS type devices inter-operate with one another.
13. FCC Certification—if individual components are used to build kiosk rather than an off-the shelf POS terminal, FCC certification may be necessary (Part 68 and/or 15).
14. OS—Linux operating system is preferred.
15. Card Reader—ATM/debit and Smart card capable; preferred is a vertical swipe, not horizontal.
16. PIN pad—no longer needs to be a separate hard key or membrane keypad. It can be embedded in the display screen as long as it complies with ANSI and VISA PIN security requirements and supports TDES and DUKPT.
17. Numeric Keypad—not required if a PIN pad is embedded in the display. However, if one is included, it should be “water splash-resistant”.
18. Printer—Thermal printer with auto-cut and partial perf capability. Should support ample size paper roll or voucher stock.
19. Display—preferably no smaller than 2.75″ wide×1.75″ high. Should be readable in casino ambient lighting. Color preferred.
20. User Interface—should be simple and easy to use. Preferably only keys/buttons necessary to patron to perform a transaction should be available. On/off button should not be exposed outside secure area of kiosk enclosure.
21. Software Interface—should provide English and Spanish prompting.
22. Serial ports—should have at least 2 available RS232 ports. One can be used to communicate with an RF client radio; the other can be used for a modem connection.

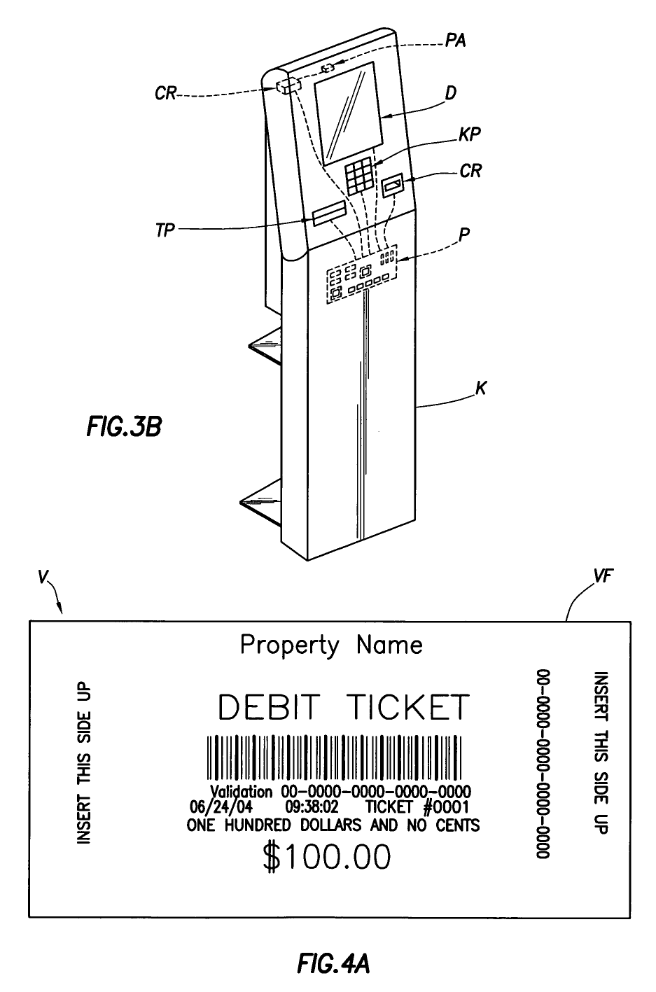

FIG. 3B illustrates kiosk hardware components, including RF client radio CR, patch antenna PA, display D, keypad KP, card reader CR, processor P and ticket printer TP.

Table I lists design components to be considered for the most effective implementations. Regardless of the options chosen, the kiosk would preferably support both wired and wireless connectivity in case a particular casino or jurisdiction prohibits one or the other.

Likewise, because gaming regulatory requirements vary by jurisdiction, options 1, 2, 6, 7, 11, and 12 of Table I need to support two configurations relative to the Gaming Environment server:
1. GE located at processors data center.
2. GE located within the casino.

FIGS. 5 through 19 include diagrams of each of the design option of Table 1. The pros and cons of each design option as listed below. Pros are listed with a prefix of “+” and cons are listed with a prefix of “↓”.

### FIG. 5—Design #1: GE Server Delivers Funds

+ Completely wireless at slot floor level which eliminates the need to pull cables to slot banks. This mobility can minimize device downtime when slot floor reconfigurations occur.
+ Visa PED certified terminal can save developmental cost and time to market over a thin client that is not certified.
+ Because of the thick client, the proprietary wireless solution can be used.
+ The proprietary wireless product has already proven itself within a casino environment.
+ Server level software can be leveraged for the EOB kiosk system.
+ Should require less development resources from gaming machine manufacturer.
↓ GE server may need to reside at the casino because of funds delivery role.
↓ The kiosk system may come under more gaming regulatory scrutiny if GE delivers finds.
↓ Software changes/updates at the kiosk level require more resources to manage/implement on a thick client than on a thin client.

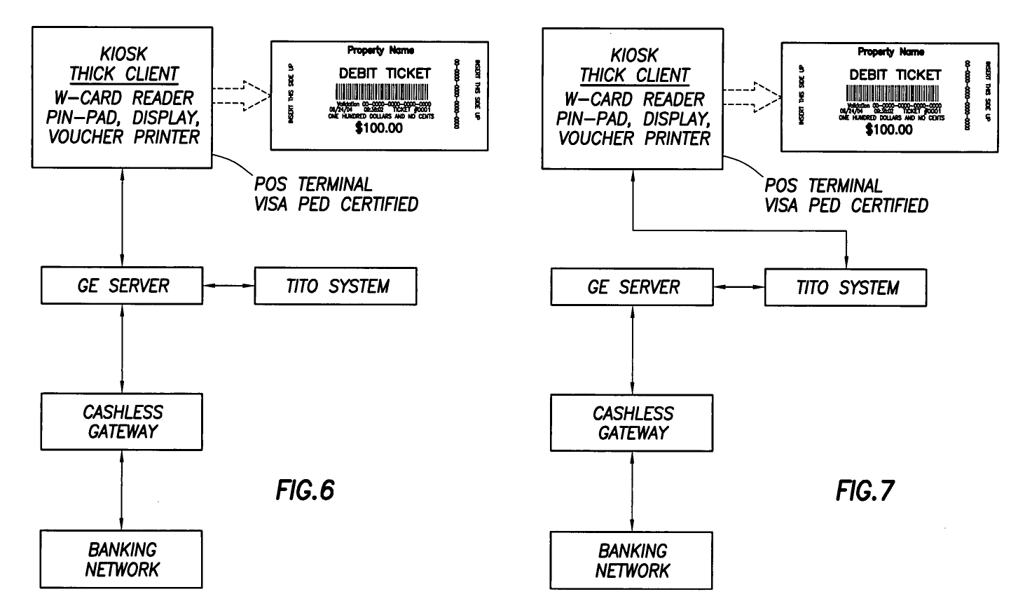

### FIG. 6—Design #2: GE Server Delivers Funds

+ Visa PED certified terminal will save development cost and time to market over a thin client that is not certified.
+ Server level software can be leveraged for the EOB kiosk system.
+ Should require less development resources from gaming machine manufacturer compared to some other designs (i.e. #3).
+ No wireless segment will save cost.
↓ Cable pulls from kiosk to GE server result in less mobile unit. Slot floor reconfigurations will create more kiosk downtime than design option #1.
↓ GE server may need to reside at the casino because of funds delivery role.
↓ The kiosk system may come under more gaming regulatory scrutiny than if GE delivers funds.
↓ Software changes/updates at the kiosk level require more resources to manage/implement on a thick client than on a thin client.

### FIG. 7—Design #3: TITO Delivers Funds and Routes Auth Messaging

+ End-of-bank kiosk system should incur less scrutiny from gaming regulators because it does not deliver funds to kiosk.
+ Visa PED certified terminal will save developmental cost and time to market over a thin client that is not certified.
+ Server level software can be leveraged for the EOB kiosk system.
+ No wireless segment will save cost.
↓ Will require more development resources from gaming machine manufacturer TITO team for Auth message handling.
↓ Cable pulls from kiosk to TITO server result in less mobile unit. Slot floor reconfigurations will create more kiosk downtime than wireless solutions.
↓ Software changes/updates at the kiosk level require more resources to manage/implement on a thick client than on a thin client.

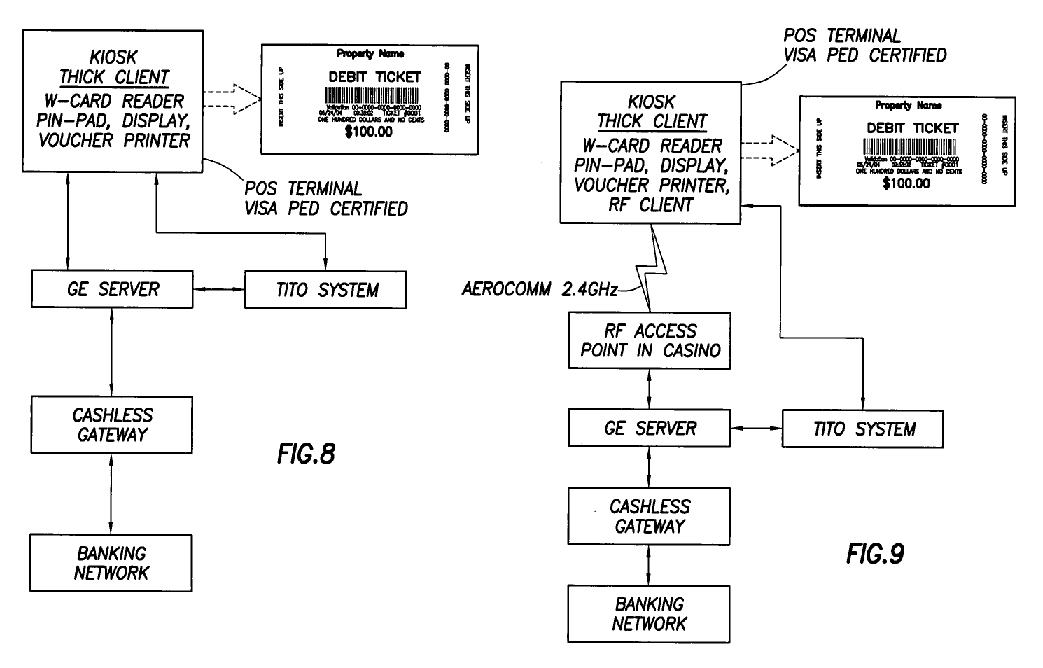

### FIG. 8—Design #4: TITO System Delivers Funds

+ Should require less development resources from gaming machine manufacturer compared to other designs (i.e. #3).
+ Visa PED certified terminal will save development cost and time to market over a thin client that is not certified.
+ Server level software can be leveraged for the EOB kiosk system.
+ No wireless segment will save cost.
↓ Cable pulls from kiosk to TITO server and to GE server result in less mobile unit. Slot floor reconfigurations will create more kiosk downtime than wireless solutions.
↓ Cable pulls to both TITO system and GE server will add time and cost to implementation.
↓ GE server may need to reside at the casino because of funds delivery role.
↓ The kiosk system may come under more gaming regulatory scrutiny if GE delivers funds.
↓ Software changes/updates at the kiosk level require more resources to manage/implement on a thick client than on a thin client.

### FIG. 9—Design #5: TITO System Delivers Funds

+ Visa PED certified terminal will save development cost and time to market over a thin client that is not certified.
+ Because of the thick client, the proprietary wireless solution can be used.
+ The proprietary wireless product has already proven itself within a casino environment.
+ Server level software can be leveraged for the EOB kiosk system.
↓ GE server may need to reside at the casino because of funds delivery role.
↓ The kiosk system may come under more gaming regulatory scrutiny if GE delivers funds.
↓ Software changes/updates at the kiosk level require more resources to manage/implement on a thick client than on a thin client.
↓ Will require cable pulls to both TITO system and RF access points in the ceiling which will add time and cost to implementation.

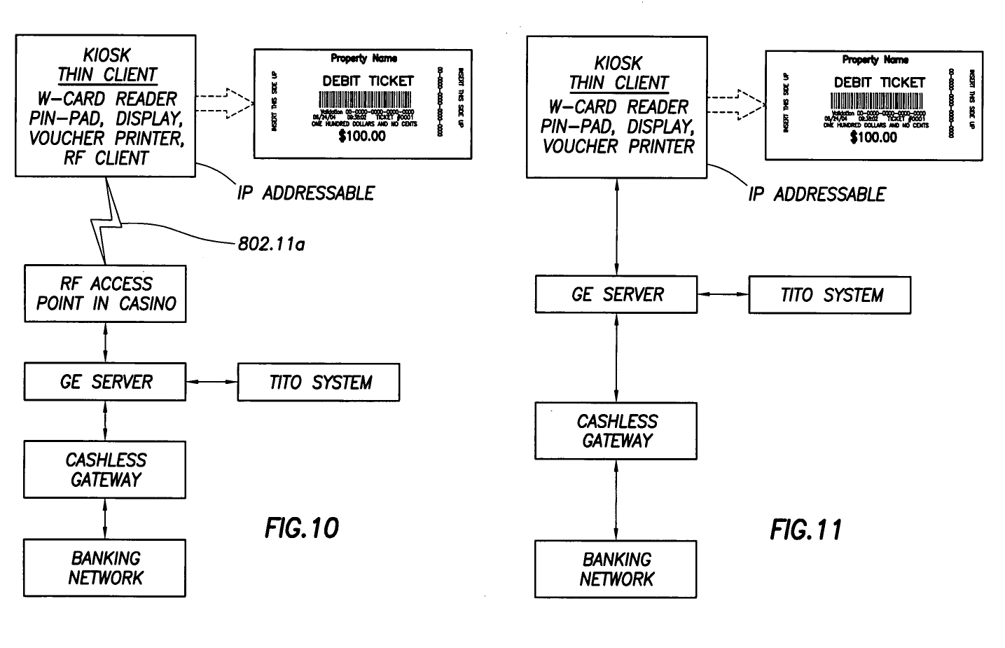

### FIG. 10—Design #6: GE Server Delivers Funds

+ Completely wireless at slot floor level which eliminates the need to pull cables to slot banks. This mobility will minimize device downtime when slot floor reconfigurations occur.
+ Software changes/updates at the kiosk level require fewer resources to manage/implement on a thin client than on a thick client.
+ Should require less development resources from gaming machine manufacturer compared to other designs.
↓ 802.11 wireless has not been proven as a reliable RF solution within a casino environment for this type of application.
↓ GE server may need to reside at the casino because of funds delivery role.
↓ The kiosk system may come under more gaming regulatory scrutiny if GE delivers funds.

### FIG. 11—Design #7: GE Server Delivers Funds

+ Software changes/updates at the kiosk level require fewer resources to manage/implement on a thin client than on a thick client.
+ Should require less development resources from gaming machine manufacturer compared to other designs (i.e. #3).
+ No wireless segment will save cost.
↓ Cable pulls from kiosk to GE server result in less mobile unit. Slot floor reconfigurations will create more kiosk downtime than wireless solutions.
↓ GE server may need to reside at the casino because of funds delivery role.
↓ The kiosk system may come under more gaming regulatory scrutiny if GE delivers funds.

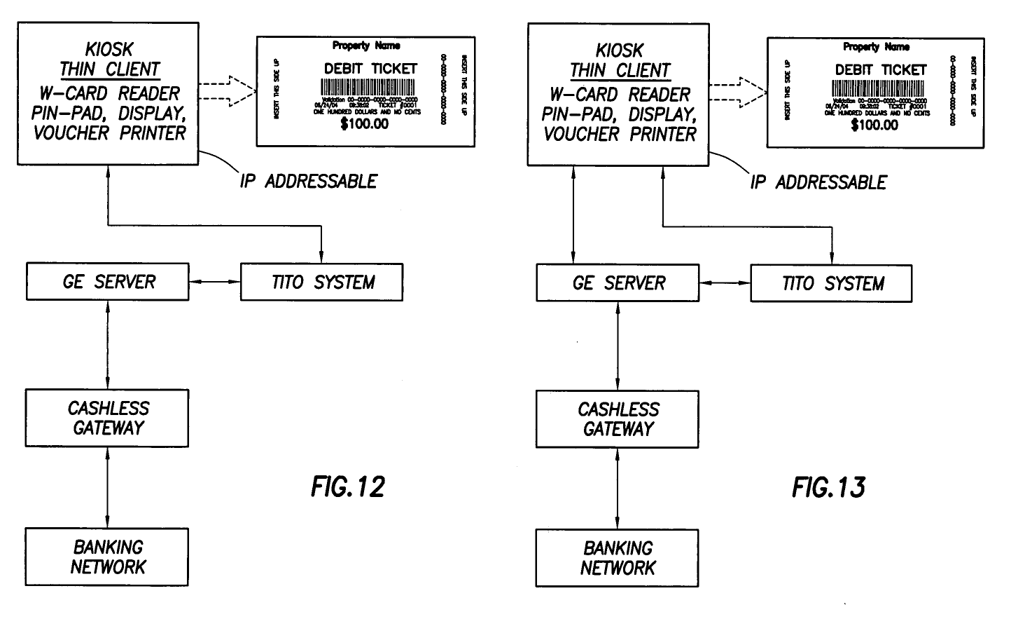

### FIG. 12—Design #8: TITO Delivers Funds and Routes Auth Messaging

+ Software changes/updates at the kiosk level require fewer resources to manage/implement on a thin client than on a thick client.
+ Kiosk system should encounter less scrutiny from gaming regulators since GE server is not delivering funds.
+ No wireless segment will save cost.
↓ Will require more development resources from gaming machine manufacturer TITO team for Auth message handling.
↓ Cable pulls from kiosk to TITO server result in less mobile unit. Slot floor reconfigurations will create more kiosk downtime than a wireless solution at the kiosk level.
↓ Will require cable pulls to both nTO system and RF access points in the ceiling which will add time and cost to implementation.

### FIG. 13—Design #9: TITO System Delivers Funds

+ Software changes/updates at the kiosk level require fewer resources to manage/implement on a thin client than on a thick client.
+ Should require less development resources from Gaming Machine Manufacturer compared to designs that require TITO to deliver funds and/or route auth messaging.
+ No wireless segment will save cost.
↓ Cable pulls from kiosk to TITO server and to GE server result in less mobile unit. Slot floor reconfigurations will create more kiosk downtime than wireless solution.
↓ Will require more development resources from gaming machine manufacturer TITO team for ticket printing.

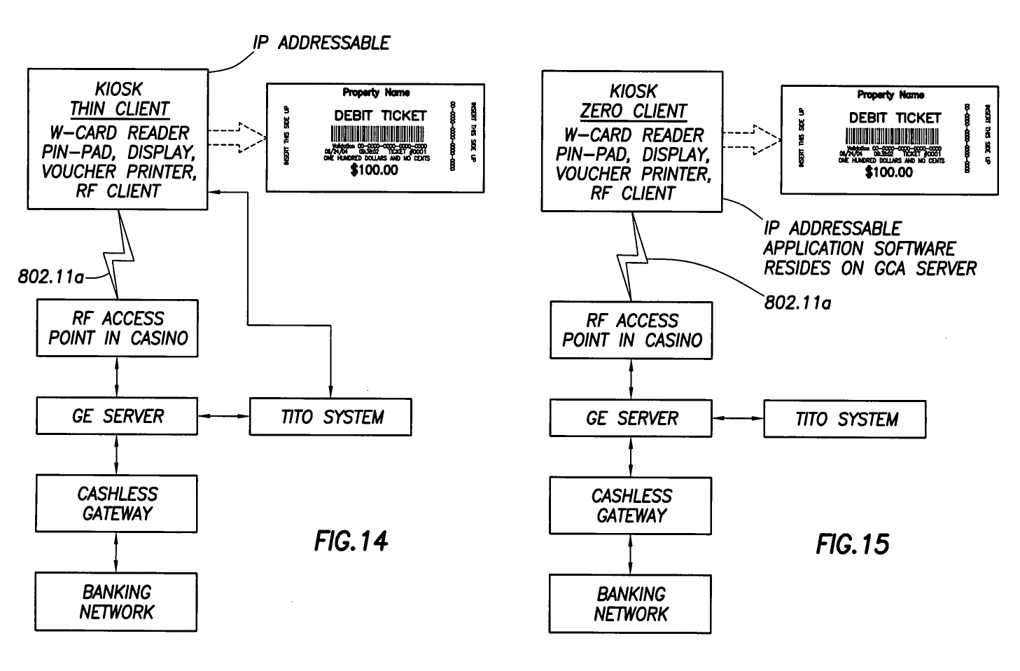

### FIG. 14—Design #10: TITO System Delivers Funds

+ Kiosk system should encounter less scrutiny from gaming regulators since GE server is not delivering funds.
↓ 802.11 wireless has not been proven as a reliable RF solution within a casino environment for this type of application. ↓ Will require more development resources from gaming machine manufacturer and TITO team for Auth message handling.
↓ Will require cable pulls to both TITO system and RF access points in the ceiling which will add time and cost to implementation.

### FIG. 15—Design #11: GE Server Delivers Funds

+ Zero client may save significant cost at the kiosk level.
+ Zero client is the most effective approach for accomplishing quick software updates/enhancements at kiosk.
+ Should require fewer resources from gaming machine manufacturer since GE Server is delivering funds.
↓ Response time is a concern.
↓ GE server may need to reside at the casino because of funds delivery role.
↓ The kiosk system may come under more gaming regulatory scrutiny if GE delivers funds.
↓ 802.11 wireless has not been proven as a reliable RF solution within a casino environment for this type of application.

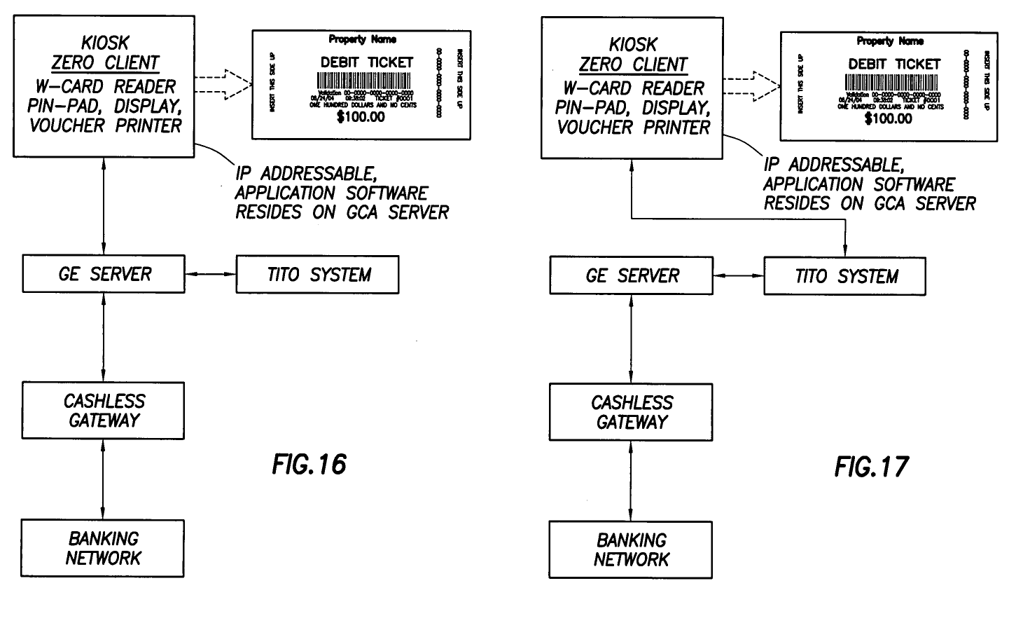

### FIG. 16—Design #12: GE Server Delivers Funds

+ Zero client may save significant cost at the kiosk level.
+ Zero client is the most effective approach for accomplishing quick software updates/enhancements at kiosk.
+ No wireless segment will lower cost.
↓ Response time is a concern.
↓ GE server may need to reside at the casino because of funds delivery role.
↓ The kiosk system may come under more gaming regulatory scrutiny if GE delivers funds.

### FIG. 17—Design #13: TITO Delivers Funds and Routes Auth Messaging

+ Zero client may save significant cost at the kiosk level.
+ Zero client is the most effective approach for accomplishing quick software updates/enhancements at kiosk.
+ No wireless segment will lower cost.
+ End-of-bank kiosk system should incur less scrutiny from gaming regulators because it does not deliver funds to kiosk.
↓ Response time is a concern.
↓ Will require more development resources from gaming machine manufacturer and TITO team for Auth message handling.

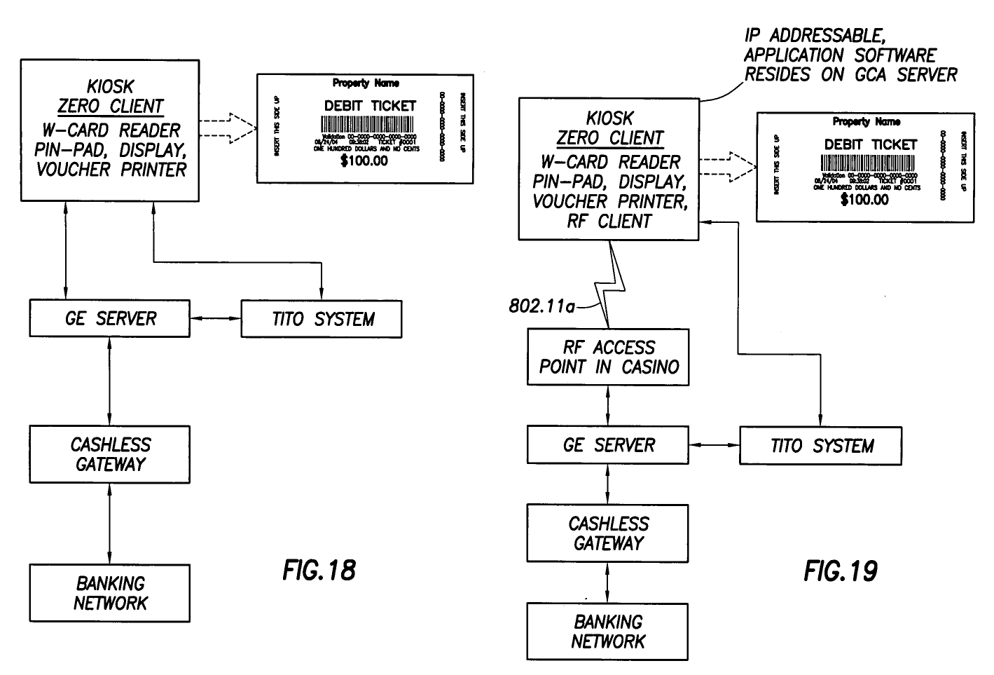

### FIG. 18—Design #14: TITO System Delivers Funds

+ Zero client may save significant cost at the kiosk level.
+ Zero client is the most effective approach for accomplishing quick software updates/enhancements at kiosk.
+ No wireless segment will lower cost.
↓ Response time is a concern.
↓ Will require more development resources from gaming machine manufacturer and TITO team for funds delivery.
↓ Cable pulls to both TITO system and GE server will add time and cost to implementation.

### FIG. 19—Design #15: TITO System Delivers Funds

+ Zero client may save significant cost at the kiosk level.
+ Zero client is the most effective approach for accomplishing quick software updates/enhancements at kiosk.
↓ Jr Response time is a concern.
↓ Jr Will require more development resources from gaming machine manufacturer and TITO team for funds delivery.
↓ 802.11 wireless has not been proven as a reliable RF solution within a casino environment for this type of application.
↓ Will require cable pulls to both TITO system and RF access points in the ceiling which will add time and cost to implementation.

Design functionability for the server level includes back-office software that can be used for reconciliation, reporting, diagnostics and troubleshooting, and interface to banking network. Because gaming regulation requirements vary by jurisdiction, the server topology should to support two configurations relative to the GE:

(1) GE located at the financial processor data center; and

(2) GE located within the casino.

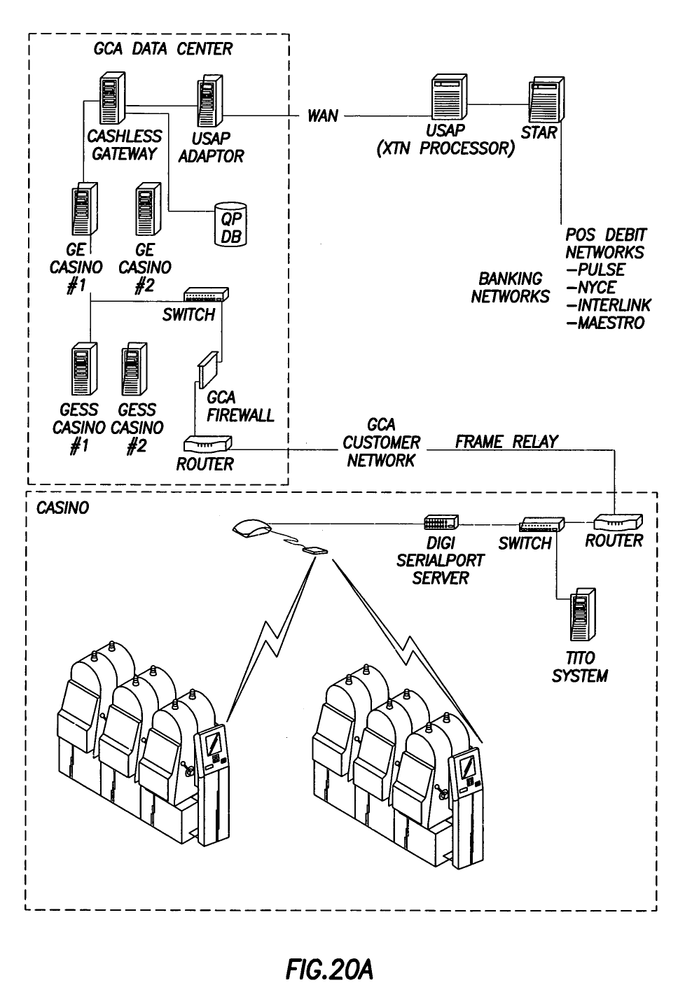

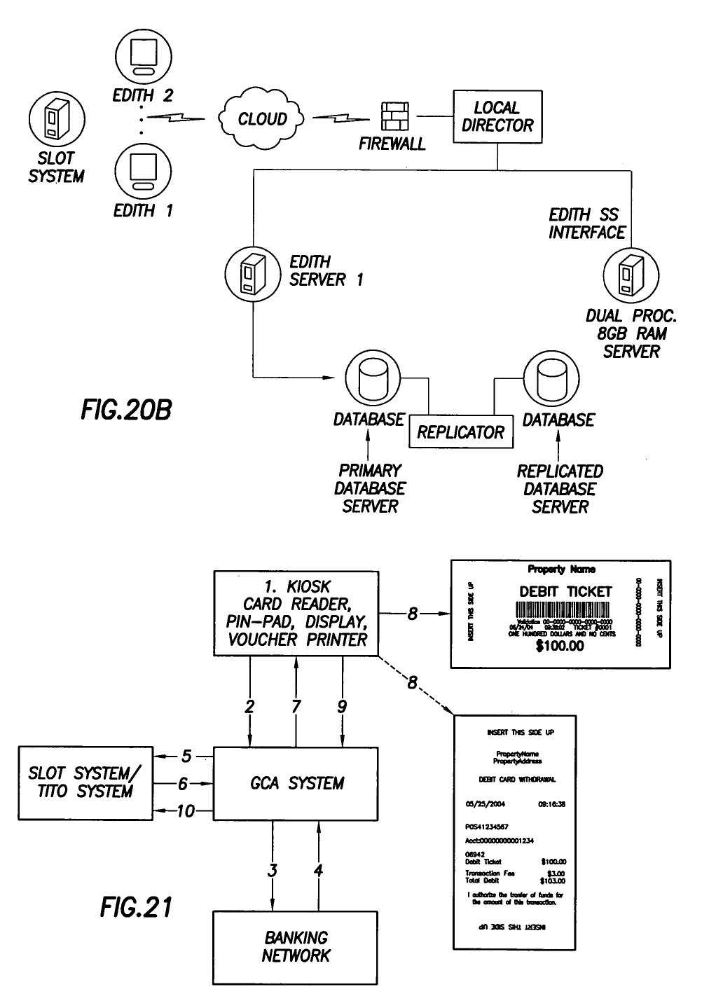

FIG. 20A illustrates a topology for an EOB kiosk and support system. FIG. 20B illustrates a server level implementation. FIGS. 21-23 illustrate three preferred transaction flow options. These figures are discussed in more detail below.

### FIG. 21—Transaction Flow Option A

1. Patron swipes or inserts debit/ATM card at kiosk, enters PIN and amount, confirms surcharge, and requests or declines a receipt.
2. Debit purchase request message is sent via RF (wireless) or cable connection to financial processor system.
3. Financial processor system sends request to banking network for debit withdrawal authorization.
4. Banking network approves debit withdrawal transaction and responds to financial processor system.
5. Financial processor system sends debit ticket request message to TITO (ticket-in/ticket-out) system.
6. TITO system responds to financial processor system with debit ticket authorization message including appropriate validation data.
7. Financial processor system forwards debit ticket authorization message to kiosk printer.
8. Kiosk prints a debit ticket (bar coded slot voucher) in the amount of the debit withdrawal request. It also prints a receipt if one was requested by the patron.
9. Kiosk sends a confirmation message to the financial processor system acknowledging that the debit ticket (and receipt if one was requested) was successfully printed.
10. The financial processor system sends a confirmation message to the TITO system acknowledging that the debit ticket was successfully printed.
11. The patron can redeem the voucher for cash at the casino cage, cashier booth, or ticket redemption kiosk or insert it into the bill acceptor of any properly equipped gaming machine.

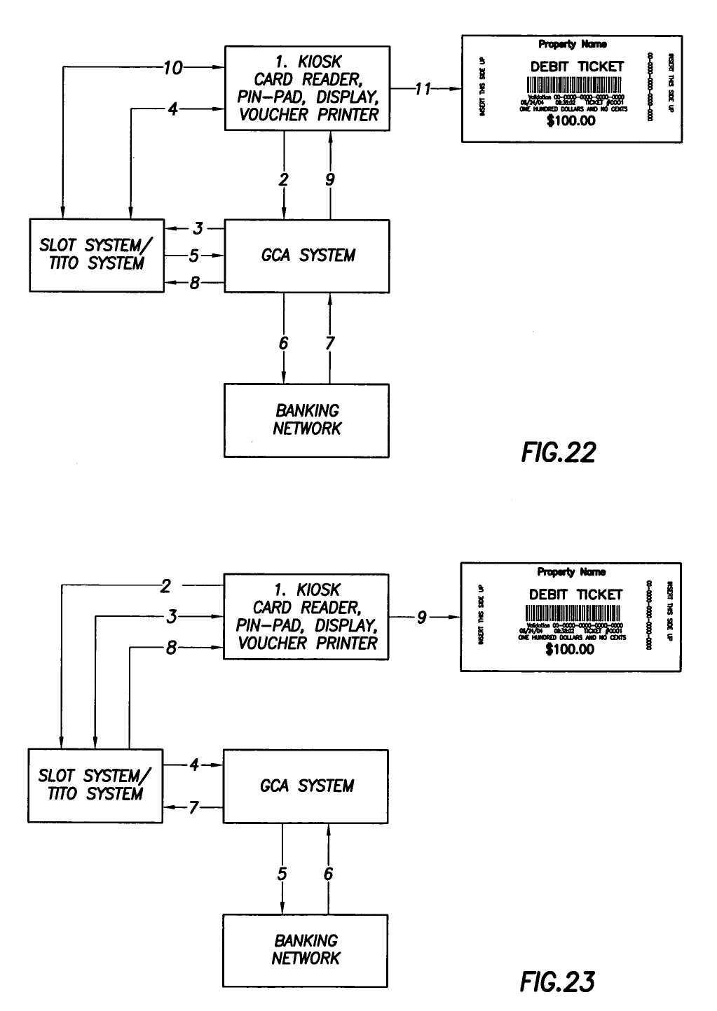

### FIG. 22—Transaction Flow Option B

1. Patron swipes or inserts debit/ATM card at kiosk, enters PIN and amount, confirms surcharge, and requests or declines a receipt.
2. Debit purchase request message is sent via RF (wireless) or cable connection to financial processor system.
3. Financial processor system sends a request to TITO system (ticket-in/ticket-out system) to verify that slot voucher printer is on-line and in a ‘ready state’ to print voucher.
4. TITO system verifies printer status via RF or cable connection
5. TITO system sends message back to financial processor system confirming that the printer is on-line and ready.
6. Financial processor system sends request to banking network for debit withdrawal authorization.
7. Banking network approves debit withdrawal transaction and responds to financial processor system.
8. Financial processor system sends authorization message to TITO system to generate a debit ticket (bar coded slot voucher).
9. Financial processor system sends a message to kiosk to display the text: “Transferring Your Funds”.
10. TITO system sends a message to the voucher printer to print a debit ticket in the amount of the debit withdrawal request.
11. The voucher printer generates a debit ticket in the amount of the debit withdrawal request. It also prints a receipt if one was requested by the patron.
12. The patron can redeem the debit ticket for cash at the casino cage or cashier booth or insert it into the bill acceptor of any properly equipped gaming machine.

### FIG. 23—Transaction Flow Option C

1. Patron swipes or inserts debit/ATM card at kiosk, enters PIN and amount, confirms surcharge, and requests or declines a receipt.
2. Debit purchase request message is sent via RF (wireless) or cable connection to TITO system.
3. TITO system verifies printer status
4. TITO system forwards debit withdrawal request to financial processor system.
5. Financial processor system sends request to banking network for debit withdrawal authorization.
6. Banking network approves debit withdrawal transaction and responds to financial processor system.
7. Financial processor system sends authorization message to TITO system to generate a debit ticket (bar coded slot voucher).
8. TITO system sends a message to the voucher printer to print a debit ticket in the amount of the debit withdrawal request.
9. The voucher printer generates a debit ticket in the amount of the debit withdrawal request. It also prints a receipt if one was requested by the patron.
10. The patron can redeem the debit ticket for cash at the casino cage or cashier booth or insert it into the bill acceptor of any properly equipped gaming machine.

In order to expressly exhibit a sense of social responsibility, the instant invention includes a further feature. This feature can be incorporated into the stand-alone kiosk of the instant invention, although it can be incorporated as well into electronic funds transfer equipment of a casino-based ATM or into POS/EFT equipment integrated into and/or with a gaming or a slot machine. The invention involves providing a player or patron an option for selecting a “personal daily limit” for electronic funds transfer for gaming. The patron or player may also be provided with an option to select a time limit for the “personal daily limit.” Such time limit would be a time period, such as six months, for which the player wishes the personal daily limit to apply to that card. Having selected a “personal daily limit,” the electronic funds transfer system will not grant an electronic funds transfer with regard to that card in a gaming establishment, or for gaming activity, to the extent that the funds for that day exceed the “personal daily limit” then in effect.

The personal daily limit could have a casino wide maximum that applied to everyone, as well. A player-selected personal daily limit safeguards against compulsive gambling in the heat of the moment with a greater amount then originally planned.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. Apparatus for purchase of slot vouchers with electronic funds on a gaming floor, comprising:
a kiosk located on the gaming floor proximate to gaming machines but separate from a particular gaming machine, the kiosk including,
an EFT card reader;
user interactive communication equipment;
voucher issuing equipment;
means for communicating with an EFT system; and
means for communicating with a gaming floor voucher accounting system including means for validating a voucher issuing procedure.

2. The apparatus from claim 1 wherein the means for communicating with an EFT system includes communicating through a financial transaction processor.

3. The apparatus of claim 1 wherein the user interactive communication equipment includes a keypad and a screen.

4. The apparatus of claim 1 wherein the voucher issuing system includes voucher printer equipment.

5. The apparatus of claim 1 that includes transaction receipt issuing equipment associated with the kiosk.

6. The apparatus of claim 1 wherein the EFT system includes at least one of a commercial debit card network and commercial credit card network.

7. The apparatus of claim 1 wherein the EFT card reader includes at least one of a magnetic strip reader and a stored value reader.

8. A voucher issuing system for a gaming establishment, the voucher redeemable for at least gaming credit at a gaming machine, comprising;
entering an EFT card and an amount at a kiosk located on a gaming floor proximate to gaming machines but separate from a particular gaming machine;
securing transaction approval through an EFT system;
validating a voucher issuing procedure; and
issuing a voucher at the kiosk.

9. The method of claim 8 that includes redeeming the voucher for cash at a voucher redemption terminal.

10. The method of claim 8 that includes using the voucher for gaming credit at a gaming machine.

11. The method of claim 8 that includes issuing a receipt for the transaction.

12. The methods of claim 8 that includes redeeming the voucher for goods or services.

13. The method of claim 8 wherein the EFT system includes at least one of a commercial debit card network and a commercial credit card network.

14. The method of claim 8 wherein the EFT card reader includes at least one of a magnetic stripe reader and a stored value reader.

15. The method of claim 8 that includes entering a PIN.

16. The method of claim 8 that includes redeeming the voucher for cash or goods or services.

17. Apparatus for cashless gaming, comprising:
a plurality of kiosks located on a gaming floor, each kiosk proximate to a plurality of gaming machines and separate from a particular gaming machine; and
each kiosk providing for issuing a voucher in exchange for an electronic funds transfer.

18. The apparatus of claim 17 wherein a plurality of kiosks are each located at the end of a bank of gaming machines.

19. A method for cashless gaming, comprising:
locating a plurality of kiosks on a gaming floor proximate to a plurality of gaming machines and separate from a particular gaming machine; and
issuing a voucher in exchange for an electronic funds transfer at each kiosk.

20. The method of claim 19 that includes locating a plurality of kiosks each at an end of a bank of gaming machines.

21. A method for safeguarding cashless gaming, comprising:
associated with requesting funds from a commercial bank credit and or debit account through electronic finds transfer in a gaming establishment or for a gaming activity,
selecting by patron a personal daily limit for funds from the account for gaming; and
granting funds from the account in a gaming establishment or for a gaming activity to the extent that the personal daily limit is not exceeded.

22. A method for safeguarding cashless gaming, comprising:
associated with granting funds from a commercial bank credit and/or debit account to a patron in a gaming establishment or for a gaming activity,
providing for the patron to select a personal daily limit for funds from the account for gaming; and
granting funds from the account to the patron in a gaming environment or for a gaming activity to the extent that the personal daily limit is not exceeded.

23. The method of claims 21 or 22 wherein the personal daily limit has a time limit.

24. The method of claim 23 that includes a patron selecting the time limit.

25. The apparatus of claim 1 that includes a financial transaction processor, structured to secure authorizations for EFT transactions, in communication with the kiosk and separate from the voucher accounting system.

26. The system of claim 8 that includes placing a financial transaction processor structured to secure authorizations for EFT transactions, in communication with the kiosk and separate from the voucher accounting system.

27. The apparatus of claim 1 wherein the kiosk is located at an end of a bank of gaming machines.

28. The system of claim 8 that includes locating the kiosk at an end of a bank of gaming machines.

29. The apparatus of claim 17 that includes a financial transaction processor also in communication with the kiosks and separate from a voucher accounting system and an EFT system.

30. The method of claim 19 that includes placing a financial transaction processor in communication with the kiosk and separate from a voucher accounting system and an EFT system.

31. The system of claim 8 that includes, associated with granting funds from a commercial bank credit and/or debit account to a patron in a gaming establishment or for gaming activity, providing for the patron to select a personal daily limit for funds from the account for gaming and granting funds from the account to the patron in a gaming environment or for gaming activity to the extent that the personal daily limit is not exceeded.

32. The method of claim 19 that includes associated with granting funds from a commercial bank credit and/or debit account to a patron in a gaming establishment or for gaming activity, providing for the patron to select a personal daily limit for funds from the account for gaming and granting funds from the account to the patron in a gaming environment or for gaming activity to the extent that the personal daily limit is not exceeded.
